(19) United States
(12) Patent Application Publication
(10) Pub. No.: US 2025/0147912 A1
(43) Pub. Date: May 8, 2025

(54) ELECTRONIC DEVICE, FAST CHARGING METHOD, APPARATUS, SYSTEM, AND READABLE STORAGE MEDIUM

(71) Applicant: VIVO MOBILE COMMUNICATION CO., LTD., Dongguan (CN)

(72) Inventor: Shenlong LI, Dongguan (CN)

(73) Assignee: VIVO MOBILE COMMUNICATION CO., LTD., Dongguan (CN)

(21) Appl. No.: 19/014,206

(22) Filed: Jan. 8, 2025

Related U.S. Application Data
(63) Continuation of application No. PCT/CN2023/108155, filed on Jul. 19, 2023.

(30) Foreign Application Priority Data
Jul. 25, 2022 (CN) 202210878430.8

(51) Int. Cl. G06F 13/40

(52) U.S. Cl. CPC G06F 13/4022; G06F 2213/0042

(57) ABSTRACT

An electronic device, a fast charging method, an apparatus, a system, and a readable storage medium are provided. The electronic device includes a female connector and a switch chip. The female connector includes two groups of pins. The switch chip is separately connected to the two groups of pins. When the switch chip is in a first enabled status, one of the two groups of pins is used for charging, and the other of the two groups of pins is used for data transmission. When the switch chip is in a second enabled status, both the two groups of pins are used for charging. When the switch chip is in a third enabled status, both the two groups of pins are used for data transmission.

### CROSS-REFERENCE TO RELATED APPLICATIONS

This application is a continuation of International Application No. PCT/CN2023/108155, filed Jul. 19, 2023, which claims priority to Chinese Patent Application No. 202210878430.8, filed on Jul. 25, 2022. The contents of the above-identified applications are incorporated herein by reference in their entireties.

### TECHNICAL FIELD

This application pertains to the field of communication technologies, and specifically relates to an electronic device, a fast charging method, an apparatus, a system, and a readable storage medium.

### BACKGROUND

Currently, with development of communication technologies, electronic devices equipped with a Universal Serial Bus (USB) type-c interface can implement fast charging.

However, in a case that the electronic devices use a private fast charging protocol, when the electronic devices perform fast charging, the electronic devices need to occupy pins used for data transmission to perform fast charging. Consequently, when the electronic devices perform fast charging, data transmission cannot be performed.

### SUMMARY

Embodiments of this application aim to provide an electronic device, a fast charging method, an apparatus, a system, and a readable storage medium, to resolve a problem that data transmission cannot be performed when the electronic device uses a private fast charging protocol to perform fast charging.

According to a first aspect, an embodiment of this application provides an electronic device, including a female connector and a switch chip. The female connector includes two groups of pins. The switch chip is separately connected to the two groups of pins. When the switch chip is in a first enabled status, one of the two groups of pins is used for charging, and the other of the two groups of pins is used for data transmission. When the switch chip is in a second enabled status, both the two groups of pins are used for charging. When the switch chip is in a third enabled status, both the two groups of pins are used for data transmission.

According to a second aspect, an embodiment of this application provides a fast charging method, applied to an electronic device according to the first aspect. The method includes the following steps. When the electronic device is connected to a target device through a fast charging data cable, the target device meets a first condition, and the fast charging data cable meets a second condition, a switch chip of the electronic device is controlled to be in a first enabled status. That the target device meets a first condition includes: the target device is a device that supports a dedicated charging port (DCP) and has a data transmission capability. That the fast charging data cable meets a second condition includes: two groups of target pins of the fast charging data cable are respectively connected to two groups of cables of the fast charging data cable. The two groups of target pins are pins of the fast charging data cable corresponding to two groups of pins of the electronic device. When the switch chip is in the first enabled status, one of the two groups of pins is used for charging, and the other of the two groups of pins is used for data transmission.

According to a third aspect, an embodiment of this application provides a fast charging apparatus. The fast charging apparatus includes a control module. The control module is configured to: when an electronic device is connected to a target device through a fast charging data cable, the target device meets a first condition, and the fast charging data cable meets a second condition, control a switch chip of the electronic device to be in a first enabled status. That the target device meets a first condition includes: the target device is a device that supports a DCP and has a data transmission capability. That the fast charging data cable mects a second condition includes: two groups of target pins of the fast charging data cable are respectively connected to two groups of cables of the fast charging data cable. The two groups of target pins are pins of the fast charging data cable corresponding to two groups of pins of the electronic device. When the switch chip is in the first enabled status, one of the two groups of pins is used for charging, and the other of the two groups of pins is used for data transmission.

According to a fourth aspect, an embodiment of this application provides a fast charging system. The fast charging system includes a target device, a fast charging data cable, and the electronic device according to the first aspect. The fast charging data cable is separately connected to a female connector of the electronic device and a port of the target device. The fast charging data cable includes two groups of target pins and two groups of cables. The two groups of target pins are respectively connected to the two groups of cables, and the two groups of target pins are respectively connected to two groups of pins of the female connector.

According to a fifth aspect, an embodiment of this application provides an electronic device. The electronic device includes a processor and a memory, the memory stores a program or an instruction that can be run on the processor, and when the program or the instruction is executed by the processor, the steps of the method according to the second aspect are implemented.

According to a sixth aspect, an embodiment of this application provides a readable storage medium. The readable storage medium stores a program or an instruction, and when the program or the instruction is executed by a processor, the steps of the method according to the second aspect are implemented.

According to a seventh aspect, an embodiment of this application provides a chip. The chip includes a processor and a communication interface, the communication interface is coupled to the processor, and the processor is configured to run a program or an instruction to implement the method according to the second aspect.

According to an eighth aspect, an embodiment of this application provides a computer program product. The program product is stored in a storage medium, and the program product is executed by at least one processor to implement the method according to the second aspect.

In the embodiments of this application, in a case that the switch chip of the electronic device is in the first enabled status, one of the two groups of pins of the female connector of the electronic device is used for data transmission, and the other may be used for data transmission. In a case that the switch chip is in the second enabled status, both the two groups of pins are used for charging. In a case that the switch chip is in the third enabled status, both the two groups of pins are used for data transmission. In other words, when an enabled status of the switch chip is different, the two groups of pins of the female connector may be separately used for data transmission or charging. Therefore, when the electronic device performs fast charging by using a private fast charging protocol, the electronic device may implement fast charging or may perform data transmission.

### BRIEF DESCRIPTION OF DRAWINGS

FIG. 1 is a first schematic diagram of a structure of an electronic device according to an embodiment of this application;

FIG. 2 is a schematic diagram of a structure of a female connector of an electronic device according to an embodiment of this application;

FIG. 3 is a second schematic diagram of a structure of an electronic device according to an embodiment of this application;

FIG. 4 is a third schematic diagram of a structure of an electronic device according to an embodiment of this application;

FIG. 5A is a schematic diagram in which an electronic device is connected to a target device through a data cable according to an embodiment of this application;

FIG. 5B is a schematic diagram in which an electronic device is connected to a target device through a data cable according to another embodiment of this application;

FIG. 6 is a fourth schematic diagram of a structure of an electronic device according to an embodiment of this application;

FIG. 7 is a fifth schematic diagram of a structure of an electronic device according to an embodiment of this application;

FIG. 8 is a flowchart of a fast charging method according to an embodiment of this application;

FIG. 9 is a first schematic diagram of a structure of a fast charging system according to an embodiment of this application;

FIG. 10 is a diagram of a structure of a male connector of a fast charging data cable according to an embodiment of this application;

FIG. 11 is a second schematic diagram of a structure of a fast charging system according to an embodiment of this application;

FIG. 12 is a schematic diagram of a structure of a fast charging apparatus according to an embodiment of this application;

FIG. 13 is a schematic diagram of a structure of an electronic device according to an embodiment of this application; and

FIG. 14 is a schematic diagram of hardware of an electronic device according to an embodiment of this application.

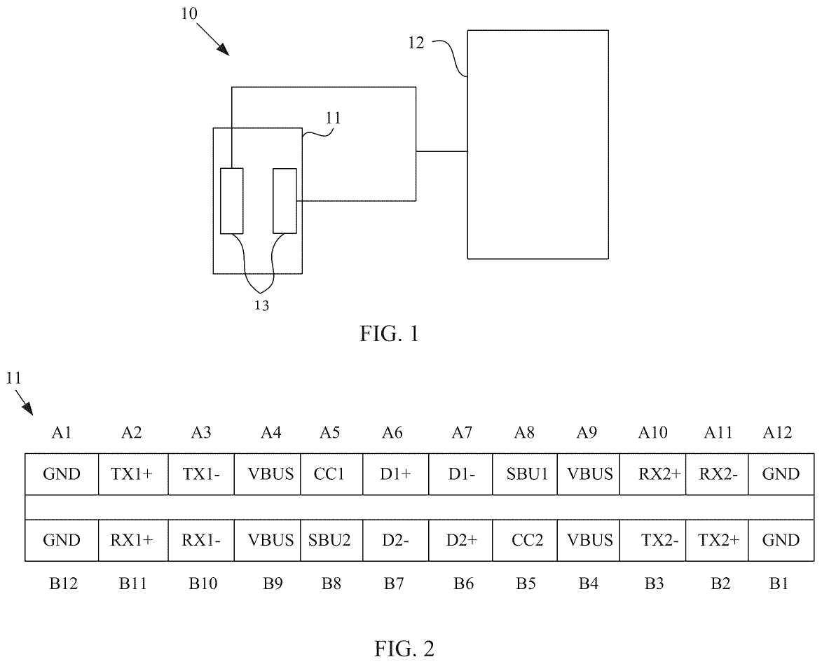

Reference numerals in FIG. 1 to FIG. 11 are as follows:
10: electronic device; 11: female connector; 12: switch chip; 13: two groups of pins; 14: first switch group; 15: second switch group; 16: application processor; 17: protocol chip; 18: first pin; 19: second pin; 20: third pin; 21: fourth pin; 24: fifth pin; 25: sixth pin; 26: seventh pin; 27: eighth pin; 28: fast charging data cable; 29: target device; 30: third switch; 31: fourth switch; 32: fifth switch; 33: sixth switch; 34: seventh switch; 35: eighth switch; 36: ninth switch; 37: tenth switch; 38: eleventh switch; 39: twelfth switch; 40: thirteenth switch; 41: fourteenth switch; 42: power supply adapter; 43: adapter cable; 44: port of target device; 45: two groups of target pins; 46: two groups of cables; 100: fast charging system;
a1: first end of first switch group; b1: second end of first switch group; c1: third end of first switch group; e1: fourth end of first switch group; f1: fifth end of first switch group; g1: sixth end of first switch group;
a2: first end of second switch group; b2: second end of second switch group; c2: third end of second switch group; e2: fourth end of second switch group; f2: fifth end of second switch group; g2: sixth end of second switch group.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

The following describes some terms/nouns used in the embodiments of this application.

BC 1.2 (Battery Charging v1.2) protocol definition:

BC 1.2 is a protocol formulated by the BC team of a USB standardization organization (USB-IF (Implementers Forum)). The protocol is mainly used to standardize requirements on battery charging. The protocol was first implemented based on the USB 2.0 protocol.

BC 1.2 charging port:

The USB 2.0 protocol specifies that a maximum current extracted from a USB charger by a peripheral device is 500 mA. A current limit of 500 mA cannot meet increasing requirements on fast charging. Therefore, the BC 1.2 protocol introduces a charging port identification mechanism, which mainly includes the following several USB port types:
(1) Standard Downstream Port (SDP): An SDP supports a USB protocol, and a maximum current of 500 mA. It may be understood that the SDP is the same as a port defined in the USB 2.0 specification, that is, the SDP is a typical port commonly used in a desktop computer and a laptop computer.
(2) Dedicated Charging Port (DCP): A DCP does not support a data protocol, supports only fast charging, and can provide a high current. For example, the DCP is mainly used for a dedicated charger such as a wall charger.
(3) Charging Downstream Port (CDP): A CDP supports both a data protocol and fast charging, and the CDP can provide a current of 1.5 A.

Power supply device: A device that provides electrical energy and is connected to a charging device through a cable, such as a power adapter.

Charging device: A device that receives electrical energy through a cable, for example, a mobile terminal or a laptop computer.

Cable electronic label: A chip that can read information such as an attribute, a power transmission capability, a data transmission capability, and an Identity Document (ID) of a cable.

USB-Power Delivery (USB-PD) protocol: An output interface of a power supply device such as a charger that supports a USB-PD protocol is a Type-C interface.

USB Type-C interface: A USB Type-C interface is a USB interface that can be used when inserted upside down or downside up, in any orientation. No matter how the USB Type-C interface is inserted, a connection to a power supply is correct. Since a socket contains two groups of data cables D+/D− connected together, the data cables are connected when the Type-C interface is inserted in any orientation. The TX/RX used for high-speed communication of the USB Type-C interface cannot be connected together. Therefore, a CC pin of the USB Type-C interface is used for identifying the insertion orientation of the Type-C interface and routing the TX/RX via a hardware line to ensure correct configuration.

Further, the Type-C interface supports power transmission with maximum power of 100 W and a maximum transmission speed of 10 Gbps.

Data Role of the Type-C interface:

In a USB 2.0 interface, the USB defines three roles based on a data transmission direction: a host port, a device port, and an On-The-Go (OTG) port. A device that supports the OTG may be used as a host, or may be used as a device. The OTG technology allows data transmission between devices without a host. In the Type-C interface, the definition is modified. A modified definition is shown in Table a.

TABLE a

| | |
|---|---|
| DFP | A downstream port, with a full English name of Downstream |
| | Facing Port. The DFP may be understood as a host, and provides a |
| | Vbus pin and a Vonn pin that can receive data. In the Type-C, the |
| | DFP, for example, means downlink transmission of data. However, |
| | in a general sense, the DFP means a device that sends data |
| | downstream and provides external power supply. |
| UFP | An upstream port, with a full English name of Upstream Facing |
| | Port. The UFP may be understood as a device, and takes power |
| | from a Vbus pin and provides data. A typical device that supports |
| | the UFP is a USB drive. |
| DRP | A dual role port, with a full English name of Dual Role Port. The |
| | DRP is similar to OTG. The DRP may be either a DFP (Host) or a |
| | UFP, or may be dynamically switched between a DFP and a UFP. |
| | A typical device that supports the DRP is a notebook. A role of a |
| | device when it is connected is determined by a power role of a |
| | port, and can be subsequently changed through a switch process |
| | (if a USB-PD protocol is supported). |

At present, a data role of the USB Type-C interface has to be consistent with a power role in a case that the USB-PD protocol is not involved. This is because the Type-C protocol does not provide an additional mechanism to negotiate a data role separately. In other words, a power supply side also acts as a host of data, and a charging side (a power receiving side) acts as a device of data.

The following describes in detail an electronic device, a fast charging method, a fast charging apparatus, a fast charging system, and a readable storage medium provided in the embodiments of this application through specific embodiments and application scenarios thereof with reference to the accompanying drawings.

In the related technology, for an original private fast charging protocol based on the BC 1.2 fast charging protocol and a derived protocol, when an electronic device performs fast charging, the electronic device needs to occupy a channel used for data transmission to perform fast charging (transmitting a private protocol). Consequently, when the electronic device performs fast charging, data transmission cannot be performed.

Based on the foregoing problem, an embodiment of this application provides an electronic device, a female connector, and a switch chip. The female connector includes two groups of pins, and the switch chip is separately connected to the two groups of pins. When the switch chip is in a different enabled status, roles of the two groups of pins may be different. In some embodiments, in a case that the switch chip is in a first enabled status, one of the two groups of pins is used for charging, and the other is used for data transmission. In a case that the switch chip is in a second enabled status, both the two groups of pins are used for charging. In a case that the switch chip is in a third enabled status, both the two groups of pins are used for data transmission. In this way, when the electronic device performs fast charging by using the private fast charging protocol, the switch chip may be controlled to be in the first enabled status, so that the electronic device can simultaneously implement fast charging (private protocol) and data transmission.

An embodiment of this application provides an electronic device. FIG. 1 shows a schematic diagram of a structure of an electronic device according to an embodiment of this application. As shown in FIG. 1, an electronic device 10 provided in this embodiment of this application may include a female connector 11 and a switch chip 12. The female connector 11 includes two groups of pins 13, and the switch chip 12 is separately connected to the two groups of pins 13.

In this embodiment of this application, in a case that the switch chip is in a first enabled status, one of the two groups of pins is used for charging, and the other is used for data transmission. In a case that the switch chip is in a second enabled status, both the two groups of pins are used for charging. In a case that the switch chip is in a third enabled status, both the two groups of pins are used for data transmission.

In this embodiment of this application, when the electronic device needs to simultaneously perform fast charging and data transmission, the electronic device may control the switch chip to be in the first enabled status. In some embodiments, when the electronic device is connected to a target device, and the target device is a device that supports a DCP and has a data transmission capability, the electronic device may control the switch chip to be in the first enabled status.

When the electronic device only needs to perform charging, the electronic device may control the switch chip to be in the second enabled status. In some embodiments, when the electronic device is connected to a target device, and the target device is a device that supports a DCP, the electronic device may control the switch chip to be in the second enabled status to increase charging power. It should be noted that, in this case, the target device may be a device that has a data transmission capability, or may be a device that does not have a data transmission capability. In other words, even if the target device supports data transmission, the electronic device still adjusts the switch chip to the second enabled status.

When the electronic device needs only to perform data transmission, the electronic device may control the switch chip to be in the third enabled status. In some embodiments, when the electronic device is connected to a target device, and the target device is a device that has a data transmission capability, the electronic device may control the switch chip to be in the third enabled status to improve data transmission power. It should be noted that, in this case, the target device may be a device that supports a DCP, or may be a device that does not support a DCP. In other words, even if the target device supports the DCP, the electronic device still adjusts the switch chip to the third enabled status.

For example, the female connector may include a female connector body and two groups of pins, where the two groups of pins are symmetrically disposed on a same surface of the female connector body.

For example, FIG. 2 is a schematic diagram of a structure of the female connector 11. As shown in FIG. 2, two rows of pin positions are symmetrically disposed on a surface of the female connector body: a row A of pin positions and a row B of pin positions. Each row of pin positions includes 12 pin positions. In some embodiments, the row A of pin positions includes a pin position A1 to a pin position A12, and the row B of pin positions includes a pin position B1 to a pin position B12. One pin is disposed at each pin position. When one of the two groups of pins 13 includes a D1+ pin and a D1− pin, and the other includes a D2+ pin and a D2− pin, the D1+ pin may be disposed at the pin position A6, and the D1− pin may be disposed at the pin position A7. The D2+ pin may be disposed at the pin position B6, and the D2− pin may be disposed at the pin position B7. As can be learned from FIG. 2, the D1+ pin is opposite to the D2− pin, and the D1− pin is opposite to the D2+ pin.

It should be noted that, in a female connector of a related technology, a D1+ pin is short-circuited with a D2+ pin, and a D1− pin is short-circuited with a D2− pin. In other words, there is only one group of D+, D− pins of the female connector in the related technology. However, in this embodiment of this application, the D1+ pin and the D1− pin are independent from the D2+ pin and the D2− pin, to ensure that the female connector in this embodiment of this application may include two groups of D+ and D− pins.

For example, when the switch chip is in the first enabled status, one of the two groups of pins is used for charging, and the other is used for data transmission. Therefore, when the group of pins of the two groups of pins includes the D1+ pin and the D1− pin, and the other includes the D2+ pin and the D2− pin, one possibility is that the D1+ pin and the D1− pin are used for charging, and the D2+ pin and the D2− pin are used for data transmission; and another possibility is that the D1+ pin and the D1− pin are used for data transmission and the D2+ pin and the D2− pin are used for charging.

For example, in addition to the two groups of pins 13, the female connector 11 may include another pin. In some embodiments, as shown in FIG. 2, the female connector may further include the following pins:
four ground pins, which are respectively disposed at a pin position A1, a pin position B1, a pin position A12, and a pin position B12;
two groups of transmit pins, where one group of transmit pins includes a TX1+ pin and a TX1− pin, which are respectively disposed at a pin position A2 and a pin position A3; and
the other group of transmit pins includes a TX2+ pin and a TX2− pin, which are respectively disposed at a pin position B2 and a pin position B3;
two groups of receive pins, where one group of receive pins includes an RX1+ pin and an RX1− pin, which are respectively disposed at a pin position B11 and a pin position B10;
and the other group of receive pins includes an RX2+ pin and an RX2− pin, which are respectively disposed at a pin position A11 and the pin position A12;
four cable bus power supply Vbus pins, which are respectively disposed at a pin position A4, a pin position B4, a pin position A9, and a pin position B9;
two channel configuration CC pins, which are a CC1 pin and a CC2 pin respectively disposed at a pin position A5 and a pin position B5, and the CC pins are used for transmission direction confirmation and correct/reverse insertion confirmation, as well as USB-PD communication; and two SBU pins, which are respectively disposed at a pin position A8 and a pin position B8, and the SBU pins are used for sidebands.

It should be noted that, for descriptions of other roles and functions of the pins except for the two groups of pins included in the female connector, refer to the related descriptions in the related technology.

For example, the female connector is a female connector that supports a USB Type-C interface. For example, the female connector may be a female connector that supports both the USB 2.0 interface and the USB Type-C interface.

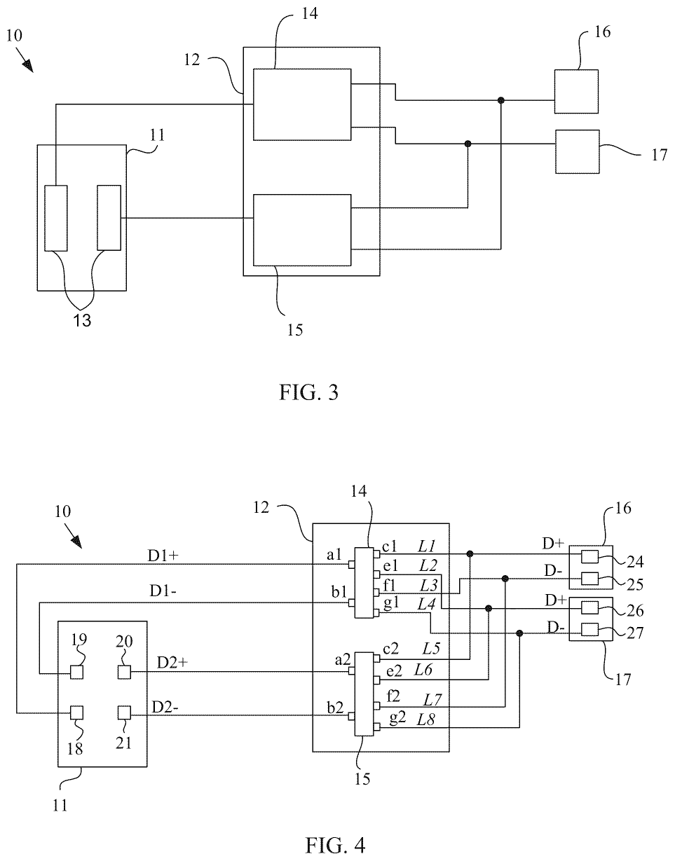

For example, with reference to FIG. 1, as shown in FIG. 3, the electronic device 10 may further include an application processor 16 and a protocol chip 17. The switch chip 12 may include a first switch group 14 and a second switch group 15. The fast charging protocol chip 17 is used for fast charging, and the application processor 16 is used for transmitting and processing data.

In a case that the switch chip 12 is in the first enabled status, one of the two groups of pins 13 is connected to the application processor 16 through the first switch group 14 for data transmission; and the other is connected to the protocol chip 17 through the second switch group 15 for charging. In this way, in a case that the electronic device 10 uses the private fast charging protocol for charging, one group of pins can support the electronic device 10 for fast charging, and the other can support data transmission. Therefore, when the electronic device 10 uses the private protocol for fast charging, the electronic device 10 can still transmit data.

In some embodiments,
in a case that the switch chip 12 is in the second enabled status, one of the two groups of pins 13 is connected to the protocol chip 17 through the first switch group 14 for charging; and the other is connected to the protocol chip 17 through the second switch group 15 for charging.

In some embodiments,
in a case that the switch chip 12 is in the third enabled status, one of the two groups of pins 13 is connected to the application processor 16 through the first switch group 14 for data transmission; and the other is connected to the application processor 16 through the second switch group 15 for data transmission.

It may be understood that when the switch chip is in a different enabled status, the two groups of pins correspond to different functions.

It should be noted that the protocol chip is a fast charging protocol chip of the electronic device. The fast charging protocol chip is a connection bridge between the electronic device and a target device. Therefore, stability of the protocol chip plays a decisive role in experience and reliability of fast charging. A stable and reliable protocol chip may adjust an output voltage in real time according to a requirement of the electronic device, and provide corresponding power in different stages of fast charging, to ensure stable and high-speed fast charging.

In this embodiment of this application, when one group of pins is used for charging, the electronic device may transmit a fast charging protocol through a channel corresponding to the group of pins, and use the fast charging protocol for fast charging, that is, to perform fast charging. The fast charging protocol is a private fast charging protocol. For example, the private fast charging protocol is a VFCP protocol, a UFCP protocol, or the like.

In this embodiment of this application, the switch chip is switched between the three enabled statuses through cooperation of the first switch group and the second switch group, so that the electronic device can realize at least one of the following functions through the two groups of pins of the female connector: data transmission and fast charging. In this way, a switch of the switch chip is controlled to be in different enabled statuses, so that the electronic device has different capabilities, thereby improving operation convenience of switching the electronic device.

For example, it is assumed that one group of pins includes a first pin and a second pin, the other includes a third pin and a fourth pin, the application processor includes a fifth pin and a sixth pin, and the protocol chip includes a seventh pin and an eighth pin. With reference to FIG. 3, as shown in FIG. 4.

A first end a1 of the first switch group 14 is connected to the first pin 18, and a second end b1 of the first switch group 14 is connected to the second pin 19. A first end a2 of the second switch group 15 is connected to the third pin 20, and a second end b2 of the second switch group 15 is connected to the fourth pin 21. Both a third end c1 of the first switch group 14 and a third end c2 of the second switch group 15 are connected to the fifth pin 24, both a fourth end e1 of the first switch group 14 and a fourth end e2 of the second switch group 15 are connected to the seventh pin 26, both a fifth end f1 of the first switch group 14 and a fifth end f2 of the second switch group 15 are connected to the sixth pin 25, and both a sixth end g1 of the first switch group 14 and a sixth end g2 of the second switch group 15 are connected to the eighth pin 27.

For example, when it is assumed that the first pin 18 is a D+ pin, the second pin 19 is a D− pin, the third pin 20 is a D+ pin, and the fourth pin 21 is a D− pin, then the fifth pin 24 and the sixth pin 25 are respectively a D+ pin and a D− pin of the application processor 16, and the seventh pin 26 and the eighth pin 27 are respectively a D+ pin and a D− pin of the protocol chip 17. In some embodiments, when it is assumed that the first pin 18 is a D− pin, the second pin 19 is a D+ pin, the third pin 20 is a D− pin, and the fourth pin 21 is a D+ pin, then the fifth pin 24 and the sixth pin 25 are respectively a D− pin and a D+ pin of the application processor 16, and the seventh pin 26 and the eighth pin 27 are respectively a D− pin and a D+ pin of the protocol chip 17.

The following describes in detail connection of the two groups of pins with the application processor and the fast charging protocol chip when the switch chip is in different enabled statuses with reference to FIG. 4.

For example, in a case that the switch chip 12 is in the first enabled status, the first end a1 of the first switch group 14 is connected to the third end c1 of the first switch group 14, so that the first pin 18 is connected to the fifth pin 24 of the application processor 16, and the second end b1 of the first switch group 14 is connected to the fifth end f1 of the first switch group 14, so that the second pin 19 is connected to the sixth pin 25 of the application processor 16; and the first end a2 of the second switch group 15 is connected to the fourth end e2 of the second switch group 15, so that the third pin 20 is connected to the seventh pin 26 of the protocol chip 17, and the second end b2 of the second switch group 15 is connected to the sixth end g2 of the second switch group 15, so that the fourth pin 21 is connected to the eighth pin 27 of the protocol chip 17. In this way, in a case that the electronic device 10 performs charging using the private fast charging protocol, the electronic device may implement data transmission through one of the two groups of pins, and implement fast charging through one of the two groups of pins.

In a case that the switch chip 12 is in the second enabled status, the first end a1 of the first switch group 14 is connected to the fourth end e1 of the first switch group 14, so that the first pin 18 is connected to the seventh pin 26 of the protocol chip 17, and the second end b1 of the first switch group 14 is connected to the sixth end g1 of the first switch group 14, so that the second pin 19 is connected to the eighth pin 27 of the protocol chip 17; and the first end a2 of the second switch group 15 is connected to the fourth end e2 of the second switch group 15, so that the third pin 20 is connected to the seventh pin 26 of the protocol chip 17, and the second end b2 of the second switch group 15 is connected to the sixth end g2 of the second switch group 15, so that the fourth pin 21 is connected to the eighth pin 27 of the protocol chip 17.

In a case that the switch chip 12 is in the third enabled status, the first end a1 of the first switch group 14 is connected to the third end c1 of the first switch group 14, so that the first pin 18 is connected to the fifth pin 24 of the application processor 16, and the second end b1 of the first switch group 14 is connected to the fifth end f1 of the first switch group 14, so that the second pin 19 is connected to the sixth pin 25 of the application processor 16; and the first end a2 of the second switch group 15 is connected to the third end c2 of the second switch group 15, so that the third pin 20 is connected to the fifth pin 24, and the second end b2 of the second switch group 15 is connected to the fifth end f2 of the second switch group 15, so that the fourth pin 21 is connected to the sixth pin 25 of the application processor 16.

In this way, one of the two groups of pins may be controlled by using the first switch group to be connected to the application processor or the protocol chip, and the other may be controlled by using the second switch group to be connected to the application processor or the protocol chip, thereby implementing different functions of the two groups of pins.

In an example embodiment, each of the first switch group and the second switch group may include one of the following: one Double Pole Double Throw (DPDT) switch (manner 1); two Single Pole Double Throw (SPDT) switches (manner 2); or four single pole single throw switches (manner 3).

For example, in manner 1, as shown in FIG. 4, for example, the first switch group 14 includes a first switch, the second switch group 15 includes a second switch, and both the first switch and the second switch are DPDT switches. Two movable ends of the first switch are the first end a1 of the first switch group 14 and the second end b1 of the first switch group 14. Two fastened ends corresponding to one movable end of the first switch are the third end c1 and the fourth end e1 of the first switch group 14, and two fastened ends corresponding to the other movable end of the first switch are the fifth end f1 and the sixth end g1 of the first switch group 14. Correspondingly, two movable ends of the second switch are the first end a2 and the second end b2 of the second switch group 15. Two fastened ends corresponding to one movable end of the second switch are the third end c2 and the fourth end e2 of the second switch group 15, and two fastened ends corresponding to the other movable end of the second switch are the fifth end f2 and the sixth end g2 of the second switch group 15. Each fastened end of a DPDT switch may be alternately conducted (contacted) with corresponding two movable ends of the fastened end. For example, when it is assumed that the two movable ends of the DPDT switch are a movable end 1 and a movable end 2, then at any time, the fastened end of the DPDT switch may be connected to the movable end 1, or the fastened end of the DPDT switch may be connected to the movable end 2.

In this way, the first switch is separately connected to the first pin, the second pin, the fifth pin, the sixth pin, the seventh pin, and the eighth pin, and the second switch is separately connected to the third pin, the fourth pin, the fifth pin, the sixth pin, the seventh pin, and the eighth pin. Therefore, one of the two groups of pins may be controlled by using the first switch to be connected to the application processor or the protocol chip, and the other may be controlled by using the second switch to be connected to the application processor or the protocol chip, thereby implementing different functions of the two groups of pins.

The following describes manner 1 with reference to specific examples.

For example, in manner 1, as shown in FIG. 4, it is assumed that the first pin 18 is a D1+ pin, the second pin 19 is a D1− pin, the third pin 20 is a D2+ pin, the fourth pin 21 is a D2− pin, the fifth pin 24 and the sixth pin 25 are a D+ pin and a D− pin of the application processor 16 respectively, and the seventh pin 26 and the eighth pin 27 are a D+ pin and a D− pin of the protocol chip 17 respectively. It is further assumed that a cable L1 is connected between a first fastened end of the first switch (the third end c1 of the first switch group 14) and the fifth pin 24, a cable L2 is connected between a second fastened end of the first switch (the fourth end e1 of the first switch group 14) and the seventh pin 26, a cable L3 is connected between a third fastened end of the first switch (the fifth end f1 of the first switch group 14) and the sixth pin 25, and a cable L4 is connected between a fourth fastened end of the first switch (the sixth end g1 of the first switch group 14) and the eighth pin 27. In addition, a cable L5 is connected between a first fastened end of the second switch (the third end c2 of the second switch group 15) and the fifth pin 24, a cable L6 is connected between a second fastened end of the second switch (the fourth end e2 of the second switch group 15) and the seventh pin 26, a cable L7 is connected between a third fastened end of the second switch (the fifth end f2 of the second switch group 15) and the sixth pin 25, and a cable L8 is connected between a fourth fastened end of the second switch (the sixth end g2 of the second switch group 15) and the eighth pin 27. Then:
(1) When the electronic device is not connected to a device (for example, the target device), the electronic device considers, by default, that the switch chip is in the third enabled status. In other words, the electronic device considers, by default, that both the two groups of pins of the female connector are used for data transmission. In some embodiments, refer to FIG. 4. As shown in Table 1 below:

TABLE 1
The switch chip is in the third enabled status

| Two groups of pins | Connection cable |
|---|---|
| D1+ | L1 |
| D1− | L3 |
| D2+ | L5 |
| D2− | L7 |

With reference to Table 1 and FIG. 4, it can be learned that when the switch chip is in the third enabled status, the D1+ pin is connected to the D+ pin of the application processor 16 through the connection cable L1, and the D1− pin is connected to the D− pin of the application processor 16 through the connection cable L3. In addition, the D2+ pin is connected to the D+ pin of the application processor 16 through the connection cable L5, and the D2− pin is connected to the D− pin of the application processor 16 through the connection cable L7. It can be learned that when the switch chip is in the third enabled status, the D1+ pin in the female connector is short-circuited with the D2+ pin, and the D1− pin in the female connector is short-circuited with the D2− pin. In this case, the female connector is not different from an existing Type-C interface that supports the private fast charging protocol.

For example, in a case that the female connector of the electronic device, such as a Type-C interface, is not connected to the target device (such as a power supply device), a default enabled status of the switch chip is the third enabled status.

For example, when the target device connected to the electronic device through a data cable is a charger that supports a PD protocol, the electronic device may control the switch chip to be in the third enabled status to perform data transmission.

For example, when the target device connected to the electronic device through a data cable supports both a PD protocol and OTG, the electronic device may control the switch chip to be in the third enabled status to perform data transmission.

For example, when the target device connected to the electronic device through a data cable is an OTG device without a power supply function, the electronic device may not switch a switch function, that is, maintain the switch chip in the third enabled status, so that the electronic device can reversely supply power to the target device. In other words, in this case, the electronic device may act as a power supply device, and the target device acts as a charging device.
(2) When the target device connected to the electronic device supports both a private protocol and DCP, the electronic device may control the switch chip to be in the second enabled status, so that the electronic device can perform fast charging through the two groups of pins of the female connector.

TABLE 2
The switch chip is in the second enabled status

| Two groups of pins | Connection cable |
|---|---|
| D1+ | L2 |
| D1− | L4 |
| D2+ | L6 |
| D2− | L8 |

With reference to Table 2 and FIG. 4, it can be learned that when the switch chip is in the second enabled status, the D1+ pin is connected to the D+ pin of the protocol chip 17 through the connection cable L2, and the D1− pin is connected to the D− pin of the protocol chip 17 through the connection cable L4. In addition, the D2+ pin is connected to the D+ pin of the protocol chip 17 through the connection cable L6, and the D2− pin is connected to the D− pin of the protocol chip 17 through the connection cable L8. It can be learned that when the switch chip is in the second enabled status, the D1+ pin of the female connector is short-circuited with the D2+ pin, and the D1− pin of the female connector is short-circuited with the D2− pin. In this case, the female connector is not different from an existing Type-C interface that supports the private fast charging protocol. After the electronic device is disconnected from the target device (for example, the data cable is unplugged), the electronic device may switch the switch chip to the third enabled status, that is, restore a default state.

For example, when the target device connected to the electronic device does not support OTG, for example, the target device is a power adapter that does not support OTG but supports a VFCP protocol or a UFCP protocol (that is, data of a fast charging protocol between the electronic device and the target device needs to be transmitted through D+ and D− pins), the electronic device may first determine whether the target device is a device that supports a DCP in a case that the switch chip is in the third enabled status. When the electronic device determines that the target device is the device that supports the DCP, the electronic device may switch the switch chip from the third enabled status to the second enabled status, so that the electronic device may perform fast charging or perform another operation by using the target device, for example, obtain device capability information of the target device.

For a specific method for the electronic device to determine whether the target device is the device that supports the DCP, refer to the related descriptions in the following embodiments of the fast charging method.
(3) When the target device connected to the female connector supports both a private protocol and OTG, the electronic device may control the switch chip to be in the first enabled status, so that one group of pins of the female connector are used for data transmission, and the other are used for charging. In some embodiments, refer to FIG. 4. As shown in Table 3:

TABLE 3
The switch chip is in the first enabled status

| | |
|---|---|
| Two groups of pins | Connection cable |

Data cable correctly connected to the female connector

| | |
|---|---|
| D1+ | L1 |
| D1− | L3 |
| D2+ | L6 |
| D2− | L8 |

Data cable reversely connected to the female connector

| | |
|---|---|
| D1+ | L2 |
| D1− | L4 |
| D2+ | L5 |
| D2− | L7 |

With reference to Table 3 and FIG. 4, it can be learned that when the data cable is correctly connected to the female connector, the D1+ pin is connected to the D+ pin of the application processor 16 through the connection cable L1, and the D1− pin is connected to the D− pin of the application processor 16 through the connection cable L3. In addition, the D2+ pin is connected to the D+ pin of the protocol chip 17 through the connection cable L6, and the D2− pin is connected to the D− pin of the protocol chip 17 through the connection cable L8. In other words, when the data cable is correctly connected to the female connector, the group of pins including the D1+ pin and D1− pin is used for data transmission, and the group of pins including the D2+ pin and D2− pin is used for fast charging.

When the data cable is reversely connected to the female connector, the D1+ pin is connected to the D+ pin of the protocol chip 17 through the connection cable L2, and the D1− pin is connected to the D− pin of the protocol chip 17 through the connection cable LA. In addition, the D2+ pin is connected to the D+ pin of the application processor through the connection cable L5, and the D2− pin is connected to the D− pin of the application processor 16 through the connection cable L7. In other words, when the data cable is reversely connected to the female connector, the group of pins including the D1+ pin and D1− pin is used for fast charging, and the group of pins including the D2+ pin and D2− pin is used for data transmission.

It may be understood that when the female connector supports the Type-C interface, the data cable may be connected either correctly or reversely to the female connector. Both of the two connection manners can ensure that one group of pins is used for data transmission and the other is used for fast charging. Therefore, both of the two manners belong to the first enabled status.

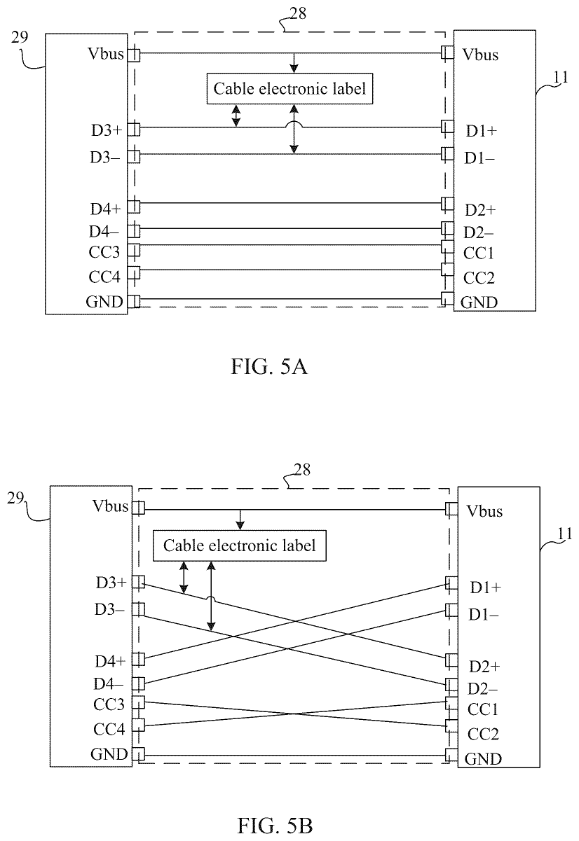

For example, in this embodiment of this application, when the female connector of the electronic device is connected to the target device through a data cable, e.g., a USB docking station, the electronic device may determine, based on a CC pin of the data cable, correct/reverse orientation of the connection between the data cable and the female connector. For example, FIG. 5A or 5B is a schematic diagram of a structure in which a female connector 11 is connected to a target device 29 through a fast charging data cable 28. FIG. 5A is a schematic diagram in which the fast charging data cable 28 is correctly connected to the female connector 11, and FIG. 5B is a schematic diagram in which the data cable 28 is reversely connected to the female connector 11.

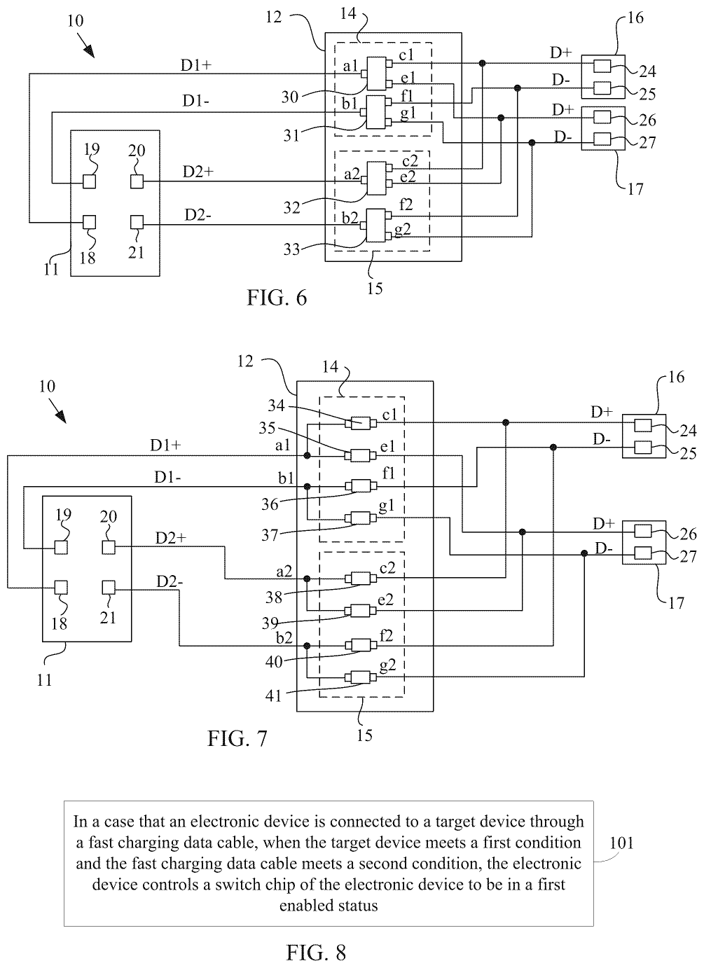

For example, in manner 2, with reference to FIG. 4, as shown in FIG. 6, the first switch group 14 includes a third switch 30 and a fourth switch 31. The second switch group 15 includes a fifth switch 32 and a sixth switch 33. The third switch 30, the fourth switch 31, the fifth switch 32 and the sixth switch 33 are all SPDT switches.

In some embodiments, a movable end of the third switch 30 is the first end a1 of the first switch group 14, one fastened end of the third switch 30 is the third end c1 of the first switch group 14, and the other fastened end of the third switch 30 is the fourth end e1 of the first switch group 14. A movable end of the fourth switch 31 is the second end b1 of the first switch group 14, one fastened end of the fourth switch 31 is the fifth end f1 of the first switch group 14, and the other fastened end of the fourth switch 31 is the sixth end g1 of the first switch group 14. A movable end of the fifth switch 32 is the first end a2 of the second switch group 15, one fastened end of the fifth switch 32 is the third end c2 of the second switch group 15, and the other fastened end of the fifth switch 32 is the fourth end e2 of the second switch group 15. A movable end of the sixth switch 33 is the second end b2 of the second switch group 15, one fastened end of the sixth switch 33 is the fifth end f2 of the second switch group 15, and the other fastened end of the sixth switch 33 is the sixth end g2 of the second switch group 15.

The following describes manner 2 in detail with reference to specific examples.

For example, as shown in FIG. 6, it is assumed that the first pin is a D1+ pin, the second pin 19 is a D1− pin, the third pin is a D2+ pin, the fourth pin is a D2− pin, the fifth pin and the sixth pin are a D+ pin and a D− pin of the application processor respectively, and the seventh pin and the eighth pin are a D+ pin and a D− pin of the protocol chip respectively, the first switch group 14 includes the third switch 30 and the fourth switch 31, and the second switch group 15 includes the fifth switch 32 and the sixth switch 33. Then:

That the switch chip 12 is in the first enabled status is, for example, as follows: The movable end of the third switch 30 (the first end a1 of the first switch group 14) is conducted with one fastened end of the third switch 30 (the third end c1 of the first switch group 14), so that the first pin 18 is connected to the fifth pin 24 of the application processor 16. The movable end of the fourth switch 31 (the second end b1 of the first switch group 14) is conducted with one fastened end of the fourth switch 31 (the fifth end f1 of the first switch group 14), so that the second pin 19 is connected to the sixth pin 25 of the application processor 16. The movable end of the fifth switch 32 (the first end a2 of the second switch group 15) is conducted with one fastened end of the fifth switch 32 (the fourth end c2 of the second switch group 15), so that the third pin 20 is connected to the seventh pin 26 of the protocol chip 17. The movable end of the sixth switch 33 (the second end b2 of the second switch group 15) is conducted with the other fastened end of the sixth switch 33 (the sixth end g2 of the second switch group 15), so that the fourth pin 21 is connected to the eighth pin 27 of the protocol chip 17. In this way, one of the two groups of pins 13 is used for data transmission and the other is used for charging.

That the switch chip is in the second enabled status is, for example, as follows: The movable end of the third switch 30 (the first end a1 of the first switch group 14) is connected to the other fastened end of the third switch 30 (the fourth end e1 of the first switch group 14), so that the first pin 18 is connected to the seventh pin 26 of the protocol chip 17. The movable end of the fourth switch 31 (the second end b1 of the first switch group 14) is connected to the other fastened end of the fourth switch 31 (the sixth end g1 of the first switch group 14), so that the second pin 19 is connected to the eighth pin 27 of the protocol chip 17. The movable end of the fifth switch 32 (the first end a2 of the second switch group 15) is connected to the other fastened end of the fifth switch 32 (the fourth end e2 of the second switch group 15), so that the third pin 20 is connected to the seventh pin 26 of the protocol chip 17. The movable end of the sixth switch 33 (the second end b2 of the second switch group 15) is connected to the other fastened end of the sixth switch 33 (the sixth end g2 of the second switch group 15), so that the fourth pin 21 is connected to the eighth pin 27 of the protocol chip 17. In this way, both the two groups of pins 13 are used for charging.

That the switch chip is in the third enabled status is, for example, as follows: The movable end of the third switch 30 (the first end a1 of the first switch group 14) is connected to one fastened end of the third switch 30 (the third end c1 of the first switch group 14), so that the first pin 18 is connected to the fifth pin 24 of the application processor 16. The movable end of the fourth switch 31 (the second end b1 of the first switch group 14) is connected to one fastened end of the fourth switch 31 (the fifth end f1 of the first switch group 14), so that the second pin 19 is connected to the sixth pin 25 of the application processor 16. The movable end of the fifth switch 32 (the first end a2 of the second switch group 15) is connected to one fastened end of the fifth switch 32 (the third end c2 of the second switch group 15), so that the third pin 20 is connected to the fifth pin 24 of the application processor 16. The movable end of the sixth switch 33 (the second end b2 of the second switch group 15) is connected to one fastened end of the sixth switch 33 (the fifth end f2 of the second switch group 15), so that the fourth pin 21 is connected to the sixth pin 25 of the application processor 16. In this way, one of the two groups of pins 13 is used for data transmission and the other is used for charging.

In this way, in manner 2, each pin of the two groups of pins of the female connector may be connected to the application processor or the protocol chip through one SPDT switch of the switch chip. Therefore, different functions of the two groups of pins of the female connector can be implemented.

For example, in manner 3, with reference to FIG. 4, as shown in FIG. 7, one of the two groups of pins 13 includes a first pin 18 and a second pin 19, and the other may include a third pin 20 and a fourth pin 21. The first switch group 14 may include a seventh switch 34, an eighth switch 35, a ninth switch 36, and a tenth switch 37. The second switch group 15 may include an eleventh switch 38, a twelfth switch 39, a thirteenth switch 40, and a fourteenth switch 41. The application processor 16 includes a fifth pin 24 and a sixth pin 25. The protocol chip 17 includes a seventh pin 26 and an eighth pin 27.

Both a movable end of the seventh switch 34 and a movable end of the eighth switch 35 are connected to the first pin 18, both a movable end of the ninth switch 36 and a movable end of the tenth switch 37 are connected to the second pin 19, both a movable end of the eleventh switch 38 and a movable end of the twelfth switch 39 are connected to the third pin 20, and both a movable end of the thirteenth switch 40 and a movable end of the fourteenth switch 41 are connected to the fourth pin 21. A fastened end of the seventh switch 34 and a fastened end of the eleventh switch 38 are connected to the fifth pin 24, and both a fastened end of the ninth switch 36 and a fastened end of the thirteenth switch 40 are connected to the sixth pin 25. Both a fastened end of the eighth switch 35 and a fastened end of the twelfth switch 39 are connected to the seventh pin 26, and both a fastened end of the tenth switch 37 and a fastened end of the fourteenth switch 41 are connected to the eighth pin 27.

It can be learned that the movable ends of the seventh switch 34 and the eighth switch 35 form a first end of the first switch group 14, the fastened ends of the ninth switch 36 and the tenth switch 37 form a second end of the first switch group 14, the fastened end of the seventh switch 34 is a third end of the first switch group 14, the fastened end of the eighth switch 35 is a fourth end of the first switch group 14, the fastened end of the ninth switch 36 is a fifth end of the first switch group 14, and the fastened end of the tenth switch 37 is a sixth end of the first switch group 14. The movable ends of the eleventh switch 38 and the twelfth switch 39 form a first end of the second switch group 15, the fastened ends of the thirteenth switch 40 and the fourteenth switch 41 form a second end of the second switch group 15, the fastened end of the eleventh switch 38 is a third end of the second switch group 15, the fastened end of the twelfth switch 39 is a fourth end of the second switch group 15, the fastened end of the thirteenth switch 40 is a fifth end of the second switch group 15, and the fastened end of the fourteenth switch 41 is a sixth end of the second switch group 15.

It should be noted that in manner 3, a “movable end” and a “fastened end” of a switch are only used to distinguish two ends of the switch, and do not limit a type of the switch.

For example, refer to FIG. 7. In manner 3, that the switch chip 12 is in the first enabled status is, for example, as follows: The seventh switch 34 is turned on, the eighth switch 35 is turned off, the ninth switch 36 is turned on, and the tenth switch 37 is turned off, so that the first pin 18 is connected to the fifth pin 24 of the application processor 16 through the seventh switch 34, and the second pin 19 is connected to the sixth pin 25 of the application processor 16 through the ninth switch 36. The eleventh switch 38 is turned off, the twelfth switch 39 is turned on, the thirteenth switch 40 is turned off, and the fourteenth switch 41 is turned on, so that the third pin 20 is connected to the seventh pin 26 of the protocol chip 17 through the twelfth switch 39, and the fourth pin 21 is connected to the eighth pin 27 of the protocol chip 17 through the fourteenth switch 41. In this way, data transmission may be performed through the first pin 18 and the second pin 19, and fast charging may be performed through the third pin 20 and the fourth pin 21.

That the switch chip 12 is in the second enabled status is, for example, as follows: The seventh switch 34 is turned off, the eighth switch 35 is turned on, the ninth switch 36 is turned off, and the tenth switch 37 is turned on, so that the first pin 18 is connected to the seventh pin 26 of the protocol chip 17 through the eighth switch 35, and the second pin 19 is connected to the eighth pin 27 of the protocol chip 17 through the tenth switch 37. The eleventh switch 38 is turned off, the twelfth switch 39 is turned on, the thirteenth switch 40 is turned off, and the fourteenth switch 41 is turned on, so that the third pin 20 is connected to the seventh pin 26 of the protocol chip 17 through the twelfth switch 39, and the fourth pin 21 is connected to the eighth pin 27 of the protocol chip 17 through the fourteenth switch 41. In this way, fast charging may be performed through the two groups of pins 13.

That the switch chip 12 is in the third enabled status is, for example, as follows: The seventh switch 34 is turned on, the eighth switch 35 is turned off, the ninth switch 36 is turned on, and the tenth switch 37 is turned off, so that the first pin 18 is connected to the fifth pin 24 of the application processor 16 through the seventh switch 34, and the second pin 19 is connected to the sixth pin 25 of the application processor 16 through the ninth switch 36. The eleventh switch 38 is turned on, the twelfth switch 39 is turned off, the thirteenth switch 40 is turned on, and the fourteenth switch 41 is turned off, so that the third pin 20 is connected to the fifth pin 24 of the application processor 16 through the eleventh switch 38, and the fourth pin 21 is connected to the sixth pin 25 of the application processor 16 through the thirteenth switch 40. In this way, data transmission may be performed through the two groups of pins 13.

For other descriptions of manner 2 and manner 3, refer to the related descriptions of manner 1.

In this way, in manner 3, each pin of the two groups of pins of the female connector may be connected to the application processor or the protocol chip through two switches of the switch chip. Therefore, different functions of the two groups of pins of the female connector can be implemented.

In the electronic device provided in the embodiments of this application, in a case that the switch chip of the electronic device is in the first enabled status, one of the two groups of pins of the female connector of the electronic device is used for data transmission, and the other may be used for data transmission. In a case that the switch chip is in the second enabled status, both the two groups of pins are used for charging. In a case that the switch chip is in the third enabled status, both the two groups of pins are used for data transmission. In other words, when an enabled status of the switch chip is different, the two groups of pins of the female connector may be separately used for data transmission or charging. Therefore, when the electronic device performs fast charging by using a private fast charging protocol, the electronic device may implement fast charging or may perform data transmission.

As shown in FIG. 8, an embodiment of this application further provides a fast charging method, applied to the electronic device in the foregoing embodiment. FIG. 8 is a flowchart of a fast charging method according to an embodiment of this application. As shown in FIG. 8, the fast charging method provided in this embodiment of this application may include the following step 101. The following uses an example in which an electronic device performs the method for description.

Step 101: In a case that the electronic device is connected to a target device through a fast charging data cable, when the target device meets a first condition and the fast charging data cable meets a second condition, the electronic device controls a switch chip of the electronic device to be in a first enabled status.

That the target device meets a first condition includes: The target device is a device that supports a DCP and has a data transmission capability. That the fast charging data cable mects a second condition includes: Two groups of target pins of the fast charging data cable are respectively connected to two groups of cables of the fast charging data cable. The two groups of target pins are pins of the fast charging data cable corresponding to two groups of pins of the electronic device.

When the switch chip is in the first enabled status, one of the two groups of pins of the female connector is used for charging, and the other is used for data transmission.

It may be understood that the two groups of pins of the electronic device are the two groups of pins of the female connector of the electronic device embodiment, for example, the two groups of D+ pins and D− pins of the female connector. Each group of target pins of the two groups of target pins includes a D+ pin and a D− pin.

That the two groups of target pins correspond to the two groups of pins of the electronic device may be understood as: The D+ pins of the two groups of target pins are in a one-to-one correspondence with the D+ pins of the two groups of pins, and the D− pins of the two groups of target pins are in a one-to-one correspondence with the D− pins of the two groups of pins.

For example, the target device may be a device having at least one of the following capabilities: a fast charging function and a data transmission function.

For example, the target device may be a power adapter, a USB docking station, or the like.

For detailed descriptions of the electronic device and the first enabled status, refer to related descriptions in the foregoing electronic device embodiment. Details are not described again in this embodiment of this application.

For example, after step 101, when the electronic device and the target device start to enter the fast charging function and the data transmission function, the electronic device may be charged by using the target device, and the electronic device and the target device may perform data transmission, for example, perform text transmission, audio transmission, video transmission, and the like.

For example, after step 101, the fast charging method provided in this embodiment of this application may further include the following steps: In a case that the switch chip is in the first enabled status, the electronic device enters a charging mode. After the electronic device is disconnected from the fast charging data cable, the electronic device may control the switch chip to be in the third enabled status. When the switch chip is in the third enabled status, both the two groups of pins of the electronic device are used for data transmission.

According to the fast charging method provided in this embodiment of this application, in a case that the electronic device is connected to the target device through the fast charging data cable, when the target device meets a first condition and the fast charging data cable meets a second condition, the fast charging apparatus may control the switch chip of the electronic device to be in the first enabled status, so that the electronic device can separately perform data transmission and fast charging through the two groups of pins of the female connector.

For example, step 101 may be implemented by using the following step 101a to step 101c.

Step 101a: In a case that the electronic device is connected to the target device through the fast charging data cable, and in a case that the target device is a device that supports a DCP, the electronic device controls the switch chip to be in a second enabled status.

When the switch chip is in the second enabled status, both the two groups of pins are used for charging.

It may be understood that in a case that the electronic device is connected to the target device through the fast charging data cable, the electronic device may first obtain port type information of the target device, and determine, based on the port type information, whether the target device is the device that supports the DCP. The port type information may include information such as a port identifier of the target device and a maximum current supported by a port of the target device.

Specifically, after the electronic device is connected to the target device, the switch chip is in the third enabled status by default. In the third enabled status, the electronic device may obtain the port type information of the target device based on the BC 1.2 protocol, and determine, based on the obtained port type information, whether the target device is the device that supports the DCP. After determining that the target device is the device that supports the DCP, the electronic device may switch the switch chip from the third enabled status to the second enabled status, so that the electronic device can obtain device capability information of the target device in the second enabled status. It is clearly that when the target device does not support a DCP, the electronic device may step determining or performing other processing.

For example, when the target device is a device that does not support a DCP, the electronic device may be a device that supports any of the following: an SDP and a CDP. For descriptions of the SDP and the CDP, refer to the related descriptions in the foregoing term explanation section.

It may be understood that, in this embodiment of this application, the electronic device switches a switch state to the second enabled status for the following purposes: On the one hand, in the second enabled status, the electronic device may obtain the device capability information of the target device. On the other hand, when the target device is the device that supports the DCP, the electronic device may perform fast charging by using the target device.

In a case that the switch chip is in the second enabled status, the electronic device may start handshake detection of a fast charging protocol, so that the electronic device may establish a communication connection to the target device through the fast charging protocol, and may obtain the device capability information of the target device.

Step 101b: The electronic device obtains the device capability information of the target device and parameter information of the fast charging data cable.

The device capability information indicates a data transmission capability of the target device.

Step 101c: In a case that the device capability information indicates that the target device has the data transmission capability, and it is determined, based on the parameter information, that the fast charging data cable meets the second condition, the electronic device controls the switch chip to be switched from the second enabled status to the first enabled status.

In this embodiment of this application, when the device capability information indicates that the target device has the data transmission capability, the electronic device may continue to determine whether the fast charging data cable meets the second condition. When it is determined that the fast charging data cable meets the second condition, the electronic device may control the switch chip to be switched from the second enabled status to the first enabled status. When the device capability information indicates that the target device does not have the data transmission capability, the electronic device may enter the fast charging function.

According to the fast charging method provided in this embodiment of this application, in a case that the electronic device is connected to the target device through the fast charging data cable, the electronic device may control the switch chip to be switched to the second enabled status in a case that it is determined that the target device is the device that supports the DCP, so that the electronic device can continue to determine whether the target device has the data transmission capability, and determine whether the fast charging cable meets the second condition, thereby accurately determining a capability of the target device and a capability of the fast charging data cable.

For example, in this embodiment of this application, after step 101b, the fast charging method provided in this embodiment of this application may further include the following step 102.

Step 102: In a case that the device capability information indicates that the target device does not have the data transmission capability, the electronic device controls the switch chip to maintain the second enabled status. In this way, the electronic device may perform fast charging by using the target device.

For example, after step 100, the fast charging method provided in this embodiment of this application may further include the following step 103.

Step 103: In a case that the target device meets a third condition, the electronic device controls the switch chip to be in a third enabled status.

That the target device meets a third condition includes: The target device is a device that has the data transmission capability and does not have a power supply capability.

In this embodiment of this application, when the switch chip is in the third enabled status, both the two groups of pins of the electronic device are used for data transmission.

For example, the fast charging method provided in this embodiment of this application may be compatible with a PD protocol. In other words, for a target device that supports the PD protocol, when the target device has a data transmission capability, the electronic device may control the switch chip to be in the third enabled status.

It may be understood that, during actual implementation, the electronic device may consider, by default, that the switch chip is in the third enabled status. When the target device has the data transmission capability, the electronic device may enable the switch chip to maintain the third enabled status and perform a high-speed data transmission function.

It is clearly that when the target device has a power supply capability, the electronic device may output prompt information to prompt a user to select an enabled status of the switch chip. For example, when “data transmission only” is selected, the electronic device controls the switch chip to be in the third enabled status. When “charging and data transmission” is selected, the electronic device may perform the above step 101. When “charging only” is selected, the electronic device may determine whether the target device is a device that supports a DCP, and perform an operation corresponding to a determining result.

In this way, when the target device has the data transmission capability and does not have the power supply capability, the electronic device may control the switch chip to be in the third enabled status, so that the electronic device can perform fast data transmission with the target device.

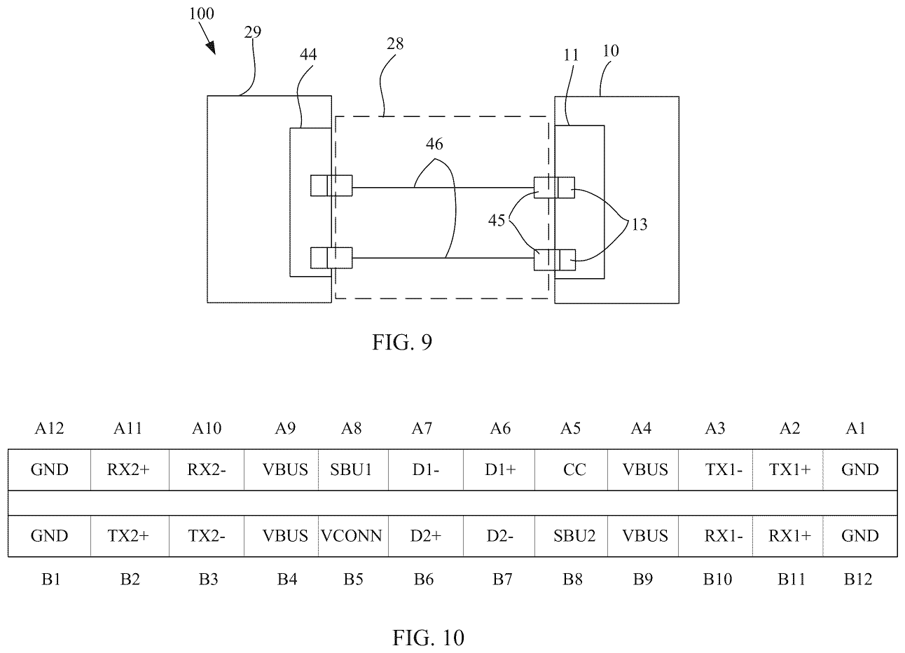

As shown in FIG. 9, an embodiment of this application provides a fast charging system. A fast charging system 100 in FIG. 9 may include a target device 29, a fast charging data cable 28 and the electronic device 10 in the foregoing electronic device embodiment. The fast charging data cable 28 is separately connected to a female connector 11 of the electronic device 10 and a port 44 of the target device 29. The fast charging data cable 28 may include two groups of target pins 45 and two groups of cables 46, the two groups of cables 46 are respectively connected to the two groups of target pins 45, and the two groups of target pins 45 are connected to two groups of pins 13 of the female connector 11.

In this embodiment of this application, each group of target pins includes a D+ pin and a D− pin.

In this embodiment of this application, each group of cables may include two cables, and a different cable of each group of cable is connected to a different pin of a group of target pins, that is, each cable is connected to a pin of a group of target pins.

It should be noted that the two groups of target pins of the fast charging data cable are in a one-to-one correspondence with the two groups of pins of the female connector of the electronic device.

In the related technology, one group of D+ and D− pins of two groups of D+ and D-pins of the fast charging data cable is connected to a cable, and the other group of D+ and D-pins is not connected to the cable. In some embodiments, in the related technology, two groups of D+ and D− pins of the fast charging data cable are short-circuited, that is, connected to a same cable. Refer to FIG. 9. An embodiment of this application may further provide a fast charging data cable 28. The fast charging data cable 28 includes two groups of target pins 45 and two groups of cables 46, and the two groups of cables 46 are respectively connected to the two groups of target pins 45. Compared with a related technology, the two groups of target pins in the fast charging cable provided in this embodiment of this application are connected to different cables.

For example, the two groups of target pins may be disposed in a male connector of the fast charging data cable.

For example, FIG. 10 is a schematic diagram of a structure of a male connector of a fast charging data cable. The male connector includes 24 pins: A1 to A12, and B1 to B12. One group of target pins of the two groups of target pins includes a D1+ pin disposed at the A6 position, a D1− pin disposed at the A7 position, and the other group of target pins of the two groups of target pins includes a D2+ pin disposed at the B6 position, and a D2− pin disposed at the B7 position. For descriptions of other pins of the male connector, refer to the related descriptions in the related technology.

In this way, when the fast charging data cable is connected to the female connector of the electronic device, one group of target pins of the two groups of target pins is connected to one group of pins of the female connector, and a formed path can be used for charging or data transmission. The other group of target pins of the two groups of target pins is connected to the other group of pins of the female connector, and a formed path may be used for data transmission or charging. In this way, the fast charging system may achieve fast charging and/or data transmission.

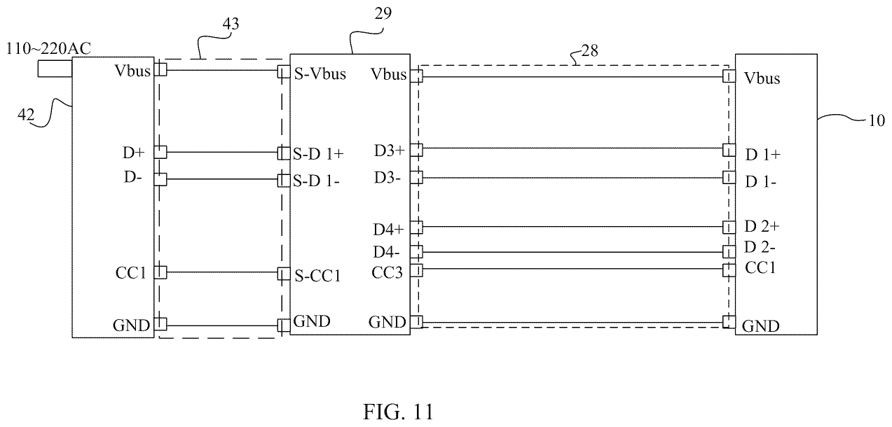

For example, with reference to FIG. 9, as shown in FIG. 11, when the target device 29 is a USB docking station, the fast charging system 100 may further include a power supply adapter 42 and an adapter cable 43. The fast charging data cable 28 is separately connected to one port of the USB docking station and the female connector 11 of the electronic device 10, and the other port of the USB docking station is connected to the power supply adapter 42 through the adapter cable 43.

For example, the power adapter may be connected to an alternating current power supply. For example, the alternating current power supply may provide an alternating current (AC) of 110 V to 220 V.

According to the fast charging system provided in this embodiment of this application, in a case that the fast charging data cable is separately connected to the female connector of the electronic device and the port of the target device, the fast charging data cable includes two groups of target pins and two groups of cables, each group of cables of the two groups of cables is connected to the two groups of target pins, and the two groups of target pins are connected to the two groups of pins of the female connector. Therefore, one group of target pins of the two groups of target pins is connected to one group of pins of the female connector, and the formed path may be used for charging or data transmission, and the other group of target pins of the two groups of target pins is connected to the other group of pins of the female connector, and the path formed may be used for data transmission or charging. In this way, the fast charging system may achieve at least one of fast charging and data transmission.

The fast charging method provided in this embodiment of this application may be executed by a fast charging apparatus (for example, the fast charging apparatus is an electronic device or an external device on an electronic device). In this embodiment of this application, the fast charging apparatus provided in the embodiments of this application is described by using an example in which the fast charging apparatus performs the fast charging method.

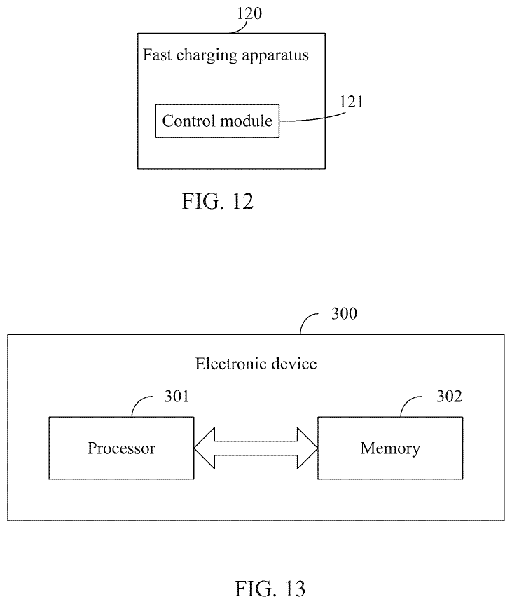

An embodiment of this application further provides a fast charging apparatus. FIG. 12 is a schematic diagram of a structure of a fast charging apparatus according to an embodiment of this application. As shown in FIG. 12, this embodiment of this application provides a fast charging apparatus. The fast charging apparatus 120 may include a control module 121.

The control module 121 is configured to: in a case that an electronic device is connected to a target device through a fast charging data cable, when the target device meets a first condition and the fast charging data cable meets a second condition, control a switch chip of the electronic device to be in a first enabled status.

That the target device meets a first condition includes: The target device is a device that supports a DCP and has a data transmission capability.

That the fast charging data cable meets a second condition includes: Two groups of target pins of the fast charging data cable are respectively connected to two groups of cables of the fast charging data cable.

The two groups of target pins are pins of the fast charging data cable corresponding to two groups of pins of the electronic device.

When the switch chip is in the first enabled status, one of the two groups of pins is used for charging, and the other is used for data transmission.

In a possible implementation, the fast charging apparatus further includes an obtaining module. The control module 121 is, for example, configured to: in a case that the target device is a device that supports a DCP, control the switch chip to be in a second enabled status, where when the switch chip is in the second enabled status, both the two groups of pins are used for charging.

The obtaining module is configured to obtain device capability information of the target device and parameter information of the fast charging data cable.

The control module 121 is, for example, configured to: in a case that the device capability information obtained by the obtaining module indicates that the target device has a data transmission capability, and it is determined, based on the parameter information, that the fast charging data cable meets the second condition, control the switch chip to be switched from the second enabled status to the first enabled status.

In a possible implementation, the control module 121 is further configured to: in a case that the device capability information indicates that the target device does not have a data transmission capability, control the switch chip to maintain the second enabled status.

In a possible implementation, the control module 121 is further configured to: in a case that the electronic device is connected to the target device through the fast charging data cable, and in a case that the target device meets a third condition, control the switch chip to be in a third enabled status.

That the target device meets a third condition includes: The target device is a device that has a data transmission capability and does not have a power supply capability.

When the switch chip is in the third enabled status, both the two groups of pins are used for data transmission.

According to the fast charging apparatus provided in this embodiment of this application, in a case that the electronic device is connected to the target device through the fast charging data cable, when the electronic device determines that the target device meets the first condition and the fast charging data cable meets the second condition, the electronic device may control the switch chip of the electronic device to be in the first enabled status, so that the electronic device can separately perform data transmission and fast charging through the two groups of pins of the female connector.

The fast charging apparatus in this embodiment of this application may be an electronic device, or may be a component such as a circuit or a chip of the electronic device. The electronic device may be a terminal, or another device other than the terminal. For example, the electronic device may be a mobile phone, a tablet computer, a notebook computer, a palmtop computer, a vehicle-mounted electronic device, a Mobile Internet Device (MID), an augmented reality (AR)/virtual reality (VR) device, a robot, a wearable device, an ultra-mobile personal computer (UMPC), a netbook, a personal digital assistant (PDA), or the like. The electronic device may be alternatively a server, a Network Attached Storage (NAS), a personal computer (PC), a television (TV), a teller machine, a self-service machine, or the like. This is not specifically limited in this embodiment of this application.

The fast charging apparatus in this embodiment of this application may be an apparatus with an operating system. The operating system may be an Android operating system, may be an iOS operating system, or may be another possible operating system. This is not specifically limited in this embodiment of this application.

The fast charging apparatus provided in this embodiment of this application can implement the processes implemented in the method embodiment of FIG. 8. To avoid repetition, details are not described herein again.

For example, as shown in FIG. 13, an embodiment of this application further provides an electronic device 300, including a processor 301 and a memory 302. The memory 302 stores a program or an instruction that can be run on the processor 301, and when the program or the instruction is executed by the processor 301, the steps of the foregoing fast charging method embodiment are implemented, and a same technical effect can be achieved. To avoid repetition, details are not described herein again.

It should be noted that the electronic device in this embodiment of this application includes the foregoing mobile electronic device and the foregoing non-mobile electronic device.

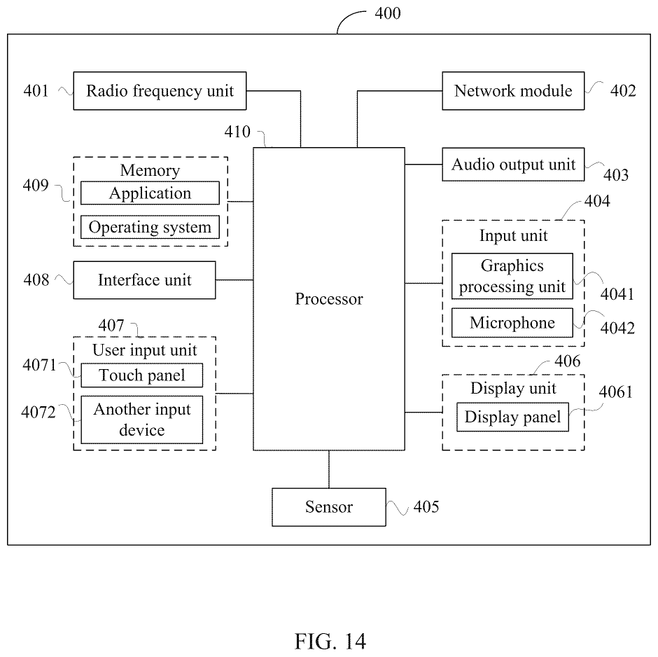

FIG. 14 is a schematic diagram of a hardware structure of an electronic device according to an embodiment of this application.

An electronic device 400 includes but is not limited to components such as a radio frequency unit 401, a network module 402, an audio output unit 403, an input unit 404, a sensor 405, a display unit 406, a user input unit 407, an interface unit 408, a memory 409, and a processor 410.

A person skilled in the art can understand that the electronic device 400 may further include the power supply (for example, a battery) that supplies power to each component. The power supply may be logically connected to the processor 410 by using a power supply management system, so as to manage functions such as charging, discharging, and power consumption by using the power supply management system. The structure of the electronic device shown in FIG. 13 does not constitute a limitation on the electronic device, and the electronic device may include more or fewer components than those shown in the figure, or combine some components, or have different component arrangements. Details are not described herein again.

The processor 410 is configured to: in a case that the electronic device is connected to a target device through a fast charging data cable, determine whether the target device meets a first condition, and determine whether the fast charging data cable meets a second condition.

The processor 410 is configured to: in a case that the electronic device is connected to the target device through the fast charging data cable, when the target device meets the first condition and the fast charging data cable meets the second condition, control a switch chip of the electronic device to be in a first enabled status.

That the target device meets a first condition includes: The target device is a device that supports a DCP and has a data transmission capability.

That the fast charging data cable meets a second condition includes: Two groups of target pins of the fast charging data cable are respectively connected to two groups of cables of the fast charging data cable.

The two groups of target pins are pins of the fast charging data cable corresponding to two groups of pins of the electronic device.

When the switch chip is in the first enabled status, one of the two groups of pins is used for charging, and the other is used for data transmission.

In a possible implementation, the processor 410 is configured to: in a case that the target device is a device that supports a DCP, control the switch chip to be in a second enabled status, where when the switch chip is in the second enabled status, both the two groups of pins are used for charging.

The obtaining module is configured to obtain device capability information of the target device and parameter information of the fast charging data cable.

The processor 410 is, for example, configured to: in a case that the device capability information obtained by the obtaining module indicates that the target device has a data transmission capability, and it is determined, based on the parameter information, that the fast charging data cable meets the second condition, control the switch chip to be switched from the second enabled status to the first enabled status.

In a possible implementation, the processor 410 is further configured to: in a case that the device capability information indicates that the target device does not have the data transmission capability, control the switch chip to maintain the second enabled status.

In a possible implementation, the processor 410 is further configured to: in a case that the electronic device is connected to the target device through the fast charging data cable, and in a case that the target device mects a third condition, control the switch chip to be in a third enabled status.

That the target device meets a third condition includes: The target device is a device that has a data transmission capability and does not have a power supply capability.

When the switch chip is in the third enabled status, both the two groups of pins are used for data transmission.

According to the electronic device 400 provided in this embodiment of this application, in a case that the electronic device is connected to the target device through the fast charging data cable, when the electronic device determines that the target device meets the first condition and the fast charging data cable meets the second condition, the electronic device may control the switch chip of the electronic device to be in the first enabled status, so that the electronic device can separately perform data transmission and fast charging through the two groups of pins of the female connector.

It should be understood that, in this embodiment of this application, the input unit 404 may include a graphics processing unit (GPU) 4041 and a microphone 4042, and the graphics processing unit 4041 processes image data of a still picture or a video obtained by an image capture apparatus (such as a camera) in a video capture mode or an image capture mode. The display unit 406 may include a display panel 4061, and the display panel 4061 may be configured in a form of a liquid crystal display, an organic light-emitting diode, or the like. The user input unit 407 includes at least one of a touch panel 4071 and another input device 4072. The touch panel 4071 is also referred to as a touchscreen. The touch panel 4071 may include two parts: a touch detection apparatus and a touch controller. The another input device 4072 may include but is not limited to a physical keyboard, a functional button (such as a volume control button or a power on/off button), a trackball, a mouse, and a joystick. Details are not described herein.

The memory 409 may be configured to store a software program and various data. The memory 409 may mainly include a first storage area for storing a program or an instruction and a second storage area for storing data. The first storage area may store an operating system, and an application or an instruction required by at least one function (for example, a sound playing function or an image playing function). In addition, the memory 409 may be a volatile memory or a non-volatile memory, or the memory 409 may include a volatile memory and a non-volatile memory. The non-volatile memory may be a Read-Only Memory (ROM), a Programmable ROM (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 109 in this embodiment of this application includes but is not limited to these memories and any memory of another proper type.

The processor 410 may include one or more processing units. For example, an application processor and a modem processor are integrated into the processor 410. The application processor mainly processes an operating system, a user interface, an application, or the like. The modem processor mainly processes a wireless communication signal, for example, a baseband processor. It may be understood that, in some embodiments, the modem processor may not be integrated into the processor 410.

An embodiment of this application further provides a readable storage medium. The readable storage medium stores a program or an instruction, and when the program or the instruction is executed by a processor, the processes of the foregoing fast charging method embodiment are implemented, and a same technical effect can be achieved. To avoid repetition, details are not described herein again.

The processor is a processor of the electronic device in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing fast charging method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium, and the program product is executed by at least one processor to implement the processes of the foregoing fast charging method embodiment, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An electronic device, comprising:
a female connector; and
a switch chip,
wherein the female connector comprises two groups of pins, and the switch chip is separately connected to the two groups of pins, wherein:
when the switch chip is in a first enabled status, one of the two groups of pins is used for charging, and the other is used for data transmission;
when the switch chip is in a second enabled status, both the two groups of pins are used for charging; or
when the switch chip is in a third enabled status, both the two groups of pins are used for data transmission.

2. The electronic device according to claim 1, wherein the electronic device further comprises a protocol chip and an application processor; and
the switch chip comprises a first switch group and a second switch group, wherein:
when the switch chip is in the first enabled status, one of the two groups of pins is connected to the application processor through the first switch group for data transmission, and the other of the two groups of pins is connected to the protocol chip through the second switch group for charging;
when the switch chip is in the third enabled status, one of the two groups of pins is connected to the protocol chip through the first switch group for data transmission, and the other of the two groups of pins is connected to the protocol chip through the second switch group for data transmission; or
when the switch chip is in the second enabled status, one of the two groups of pins is connected to the application processor through the first switch group for charging, and the other of the two groups of pins is connected to the application processor through the second switch group for charging.

3. The electronic device according to claim 2, wherein the one of the two groups of pins comprises a first pin and a second pin, the other of the two groups of pins comprises a third pin and a fourth pin, the application processor comprises a fifth pin and a sixth pin, and the protocol chip comprises a seventh pin and an eighth pin, wherein:
a first end of the first switch group is connected to the first pin, and a second end of the first switch group is connected to the second pin;
a first end of the second switch group is connected to the third pin, and a second end of the second switch group is connected to the fourth pin; and
both a third end of the first switch group and a third end of the second switch group are connected to the fifth pin, both a fourth end of the first switch group and a fourth end of the second switch group are connected to the seventh pin, both a fifth end of the first switch group and a fifth end of the second switch group are connected to the sixth pin, and both a sixth end of the first switch group and a sixth end of the second switch group are connected to the eighth pin.

4. The electronic device according to claim 3, wherein:
when the switch chip is in the first enabled status, the first end of the first switch group is connected to the third end of the first switch group, so that the first pin is connected to the fifth pin of the application processor, and the second end of the first switch group is connected to the fifth end of the first switch group, so that the second pin is connected to the sixth pin of the application processor; and the first end of the second switch group is connected to the fourth end of the second switch group, so that the third pin is connected to the seventh pin of the protocol chip, and the second end of the second switch group is connected to the sixth end of the second switch group, so that the fourth pin is connected to the eighth pin of the protocol chip;
when the switch chip is in the second enabled status, the first end of the first switch group is connected to the fourth end of the first switch group, so that the first pin is connected to the seventh pin of the protocol chip, and the second end of the first switch group is connected to the sixth end of the first switch group, so that the second pin is connected to the eighth pin of the protocol chip; and the first end of the second switch group is connected to the fourth end of the second switch group, so that the third pin is connected to the seventh pin of the protocol chip, and the second end of the second switch group is connected to the sixth end of the second switch group, so that the fourth pin is connected to the eighth pin of the protocol chip; or
when the switch chip is in the third enabled status, the first end of the first switch group is connected to the third end of the first switch group, so that the first pin is connected to the fifth pin of the application processor, and the second end of the first switch group is connected to the fifth end of the first switch group, so that the second pin is connected to the sixth pin of the application processor; and the first end of the second switch group is connected to the third end of the second switch group, so that the third pin is connected to the fifth pin of the application processor, and the second end of the second switch group is connected to the fifth fastened end of the second switch group, so that the fourth pin is connected to the sixth pin of the application processor.

5. The electronic device according to claim 1, wherein each of the two groups of pins comprises a D+ pin and a D− pin.

6. A fast charging method performed by an electronic device, comprising:
when the electronic device is connected to a target device through a fast charging data cable, the target device meets a first condition, and the fast charging data cable meets a second condition, controlling a switch chip of the electronic device to be in a first enabled status,
wherein that the target device meets a first condition comprises: the target device is a device that supports a dedicated charging port DCP and has a data transmission capability,
wherein that the fast charging data cable meets a second condition comprises: two groups of target pins of the fast charging data cable are respectively connected to two groups of cables of the fast charging data cable,
wherein the two groups of target pins are pins of the fast charging data cable corresponding to two groups of pins of the electronic device, and
wherein when the switch chip is in the first enabled status, one of the two groups of pins is used for charging, and the other is used for data transmission.

7. The method according to claim 6, wherein when the target device meets the first condition and the fast charging data cable meets the second condition, controlling the switch chip of the electronic device to be in the first enabled status comprises:
when the target device is a device that supports a DCP, controlling the switch chip to be in a second enabled status, wherein when the switch chip is in the second enabled status, both the two groups of pins are used for charging;
obtaining device capability information of the target device and parameter information of the fast charging data cable; and
when the device capability information indicates that the target device has a data transmission capability, and it is determined, based on the parameter information, that the fast charging data cable meets the second condition, controlling the switch chip to be switched from the second enabled status to the first enabled status.

8. The method according to claim 7, wherein after obtaining the device capability information of the target device, the method further comprises:
when the device capability information indicates that the target device does not have a data transmission capability, controlling the switch chip to maintain the second enabled status.

9. The method according to claim 6, further comprising:
when the electronic device is connected to the target device through the fast charging data cable, and the target device meets a third condition, controlling the switch chip to be in a third enabled status,
wherein that the target device meets a third condition comprises: the target device is a device that has a data transmission capability and does not have a power supply capability, and
wherein when the switch chip is in the third enabled status, both the two groups of pins are used for data transmission.

10. A fast charging system, comprising:
a target device;
a fast charging data cable; and
an electronic device, comprising:
a female connector; and
a switch chip,
wherein the female connector comprises two groups of pins, and the switch chip is separately connected to the two groups of pins, wherein:
when the switch chip is in a first enabled status, one of the two groups of pins is used for charging, and the other is used for data transmission;
when the switch chip is in a second enabled status, both the two groups of pins are used for charging; or
when the switch chip is in a third enabled status, both the two groups of pins are used for data transmission,
wherein the fast charging data cable is separately connected to a female connector of the electronic device and a port of the target device, and
wherein the fast charging data cable comprises two groups of target pins and two groups of cables, wherein the two groups of target pins are respectively connected to the two groups of cables, and the two groups of target pins are respectively connected to two groups of pins of the female connector.

11. The fast charging system according to claim 10, wherein the electronic device further comprises a protocol chip and an application processor; and
the switch chip comprises a first switch group and a second switch group, wherein:
when the switch chip is in the first enabled status, one of the two groups of pins is connected to the application processor through the first switch group for data transmission, and the other of the two groups of pins is connected to the protocol chip through the second switch group for charging;
when the switch chip is in the third enabled status, one of the two groups of pins is connected to the protocol chip through the first switch group for data transmission, and the other of the two groups of pins is connected to the protocol chip through the second switch group for data transmission; or
when the switch chip is in the second enabled status, one of the two groups of pins is connected to the application processor through the first switch group for charging, and the other of the two groups of pins is connected to the application processor through the second switch group for charging.

12. The fast charging system according to claim 11, wherein the one of the two groups of pins comprises a first pin and a second pin, the other of the two groups of pins comprises a third pin and a fourth pin, the application processor comprises a fifth pin and a sixth pin, and the protocol chip comprises a seventh pin and an eighth pin, wherein:
a first end of the first switch group is connected to the first pin, and a second end of the first switch group is connected to the second pin;
a first end of the second switch group is connected to the third pin, and a second end of the second switch group is connected to the fourth pin; and
both a third end of the first switch group and a third end of the second switch group are connected to the fifth pin, both a fourth end of the first switch group and a fourth end of the second switch group are connected to the seventh pin, both a fifth end of the first switch group and a fifth end of the second switch group are connected to the sixth pin, and both a sixth end of the first switch group and a sixth end of the second switch group are connected to the eighth pin.

13. The fast charging system according to claim 12, wherein:
when the switch chip is in the first enabled status, the first end of the first switch group is connected to the third end of the first switch group, so that the first pin is connected to the fifth pin of the application processor, and the second end of the first switch group is connected to the fifth end of the first switch group, so that the second pin is connected to the sixth pin of the application processor; and the first end of the second switch group is connected to the fourth end of the second switch group, so that the third pin is connected to the seventh pin of the protocol chip, and the second end of the second switch group is connected to the sixth end of the second switch group, so that the fourth pin is connected to the eighth pin of the protocol chip;
when the switch chip is in the second enabled status, the first end of the first switch group is connected to the fourth end of the first switch group, so that the first pin is connected to the seventh pin of the protocol chip, and the second end of the first switch group is connected to the sixth end of the first switch group, so that the second pin is connected to the eighth pin of the protocol chip; and the first end of the second switch group is connected to the fourth end of the second switch group, so that the third pin is connected to the seventh pin of the protocol chip, and the second end of the second switch group is connected to the sixth end of the second switch group, so that the fourth pin is connected to the eighth pin of the protocol chip; or
when the switch chip is in the third enabled status, the first end of the first switch group is connected to the third end of the first switch group, so that the first pin is connected to the fifth pin of the application processor, and the second end of the first switch group is connected to the fifth end of the first switch group, so that the second pin is connected to the sixth pin of the application processor; and the first end of the second switch group is connected to the third end of the second switch group, so that the third pin is connected to the fifth pin of the application processor, and the second end of the second switch group is connected to the fifth fastened end of the second switch group, so that the fourth pin is connected to the sixth pin of the application processor.

14. The fast charging system according to claim 10, wherein each of the two groups of pins comprises a D+ pin and a D− pin.
